(19) United States
(12) Patent Application Publication
(10) Pub. No.: US 2025/0184562 A1
(43) Pub. Date: Jun. 5, 2025

(54) INFORMATION INTERACTION METHOD AND APPARATUS, ELECTRONIC DEVICE AND STORAGE MEDIUM

(71) Applicant: Beijing Zitiao Network Technology Co., Ltd., Beijing (CN)

(72) Inventors: Peipei WU, Beijing (CN); Liyue JI, Beijing (CN); Xiaolin LI, Beijing (CN); Yang WU, Beijing (CN); Yan ZHAO, Beijing (CN)

(21) Appl. No.: 18/842,677

(22) PCT Filed: Apr. 27, 2023
(86) PCT No.: PCT/CN2023/091165

§ 371 Date: Aug. 29, 2024

(30) Foreign Application Priority Data
May 31, 2022 (CN) 202210612163.X

(51) Int. Cl. H04N 21/431; H04N 21/2187; H04N 21/4788

(52) U.S. Cl. CPC H04N 21/4316; H04N 21/4788; H04N 21/2187

(57) ABSTRACT

The present disclosure relates to the field of computer technology, and specifically to methods, apparatus, electronic devices and storage media for information interaction. An information interaction method according to embodiments of the present disclosure includes: displaying a video image in a video image display area; determining a target message and displaying the target message in the target message display area; wherein orthographic projection of the target message display area in the plane where the video image display area is located is located on the left side and/or right side of a preset central area of the video image display area.

### CROSS REFERENCE TO RELATED APPLICATIONS

This application is filed based on a Chinese patent application with application Ser. No. 202210612163.X and a filing date of May 31, 2022, titled “INFORMATION INTERACTION METHOD AND APPARATUS, ELECTRONIC DEVICE AND STORAGE MEDIUM”, and claims priority of the Chinese patent application, the content of which is incorporated herein by reference in its entirety.

### FIELD

The present disclosure relates to the field of computer technology, and specifically relates to a method, apparatus, electronic device and storage medium for information interaction.

### BACKGROUND

When watching a video, users can send messages such as bullet screens and emojis to express their viewing experience and interact with other users or hosts, thereby increasing the fun of watching videos and user participation. However, in the related technology, the display mechanism of bullet screens and emojis is relatively simple, and the interactive experience is poor.

### SUMMARY

This Summary is provided to introduce, in a simplified form, concepts that are further described in the Detailed Description. This Summary is not intended to identify key features or essential features of the claimed technical solution, nor is it intended to be used to limit the scope of the claimed technical solution.

In a first aspect, according to one or more embodiments of the present disclosure, a method for information interaction is provided, comprising:
displaying a video image in a video image display area;
determining a target message, and displaying the target message in the target message display area; wherein the orthographic projection of the target message display area in the plane where the video image display area is located is located on a left side and/or a right side of a preset central area of the video image display area.

In a second aspect, according to one or more embodiments of the present disclosure, an apparatus for information interaction is provided, comprising:
a video display unit, configured to display a video image in a video image display area;
a message display unit, configured to determine a target message, and display the target message in the target message display area; wherein the orthographic projection of the target message display area in the plane where the video image display area is located is located on a left side and/or a right side of a preset central area of the video image display area.

In a third aspect, according to one or more embodiments of the present disclosure, an electronic device is provided, including: at least one memory and at least one processor; wherein the memory is configured to store program code, and the processor is configured to call the program code stored in the memory in order to cause the electronic device to execute the information interaction method provided according to one or more embodiments of the present disclosure.

In a forth aspect, according to one or more embodiments of the present disclosure, a non-transitory computer storage medium is provided. The non-transitory computer storage medium has program code stored thereon. When the program code is executed by a computer device, the computer device is caused to execute the information interaction method provided according to one or more embodiments of the present disclosure.

According to one or more embodiments of the present disclosure, by locating the orthographic projection of the target message display area in the plane where the video image display area is located on a left side and/or a right side of a preset central area of the video image display area, the target message can be displayed in the target message display area without obstructing the central area of the video image, and the target message area may be viewed by the user together with the video image, thereby improving both the user's video viewing experience and message interaction experience.

### BRIEF DESCRIPTION OF THE FIGURES

The above and other features, advantages, and aspects of various embodiments of the present disclosure will become more apparent with reference to the following detailed description taken in conjunction with the accompanying figures. Throughout the figures, the same or similar reference numbers refer to the same or similar elements. It is to be understood that the figures are schematic and that components and elements are not necessarily drawn to scale.

FIG. 1 is a flow chart of a method for information interaction provided by an embodiment of the present disclosure;

FIG. 2 is a schematic diagram of a video image display area and a target message display area provided by an embodiment of the present disclosure;

FIG. 3 is a schematic diagram of a video image display area and a target message display area in a virtual reality space provided by an embodiment of the present disclosure; and

FIG. 4 is a schematic structural diagram of an electronic device according to an embodiment of the present disclosure.

### DETAILED DESCRIPTION OF EMBODIMENTS

Embodiments of the present disclosure will be described in more detail below with reference to the accompanying figures. Although certain embodiments of the disclosure are shown in the figures, it should be understood that the disclosure may be embodied in various forms and should not be construed as limited to the embodiments set forth herein, which rather are provided for a more thorough and complete understanding of this disclosure. It should be understood that the figures and embodiments of the present disclosure are for illustrative purposes only and are not intended to limit the scope of the present disclosure.

It should be understood that the steps described in implementations of the present disclosure may be performed in a different order and/or performed in parallel. Furthermore, implementations may include additional steps and/or omit performance of illustrated steps. The scope of the present disclosure is not limited in this regard.

As used herein, the term “include” and its variations are open-ended, that is, “including but not limited to”. The term “based on” means “based at least in part on”; the term “one embodiment” means “at least one embodiment”; the term “another embodiment” means “at least one additional embodiment”; and the term “some embodiments” means “at least some embodiments”. The term “responsive to” and related terms means that one signal or event is affected by another signal or event to some extent, but not necessarily completely or directly. If event x occurs “in response to” event y, x may respond to y, directly or indirectly. For example, the occurrence of y may eventually lead to the occurrence of x, but there may be other intermediate events and/or conditions. In other cases, y may not necessarily cause x to occur, and x may occur even if y has not yet occurred. Furthermore, the term “responsive to” may also mean “responsive at least in part to.”

The term “determine” broadly includes a wide variety of actions, which may include retrieving, calculating, calculating, processing, deriving, investigating, looking up (e.g., in a table, database, or other data structure), ascertaining, and similar actions, and also include receiving (e.g., receiving information), accessing (e.g., accessing data in memory), and similar actions, as well as parsing, selecting, selecting, creating, and similar actions, and the like. Relevant definitions of other terms will be given in the description below. Relevant definitions of other terms will be given in the description below.

It should be noted that concepts such as “first” and “second” mentioned in this disclosure are only used to distinguish different apparatus, modules or units, and are not used to limit the order or interdependence of functions performed by these apparatus, modules or units.

It should be noted that the modifications of “one” and “plurality” mentioned in this disclosure are illustrative and not restrictive. Those skilled in the art will understand that unless the context clearly indicates otherwise, it should be understood as “one or multiple”.

For the purposes of this disclosure, the phrase “A and/or B” means (A), (B) or (A and B).

The names of messages or information exchanged between multiple apparatus in the implementations of the present disclosure are for illustrative purposes only and are not used to limit the scope of these messages or information.

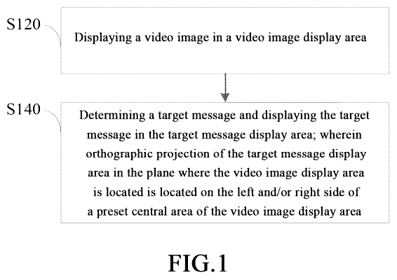

Referring to FIG. 1, FIG. 1 shows a flowchart of a method for information interaction 100 provided in an embodiment of the present disclosure. The method 100 includes steps S120 to S140.

Step S120: Display the video image in the video image display area.

In some embodiments, a video image may be presented in a video image display area based on the acquired video stream. Exemplarily, the video stream may adopt encoding formats such as H.265, H.264, MPEG-4, etc. In a specific implementation, the client may receive the live video stream sent by the server, and display the live video image in the video image display area based on the live video stream.

In some embodiments, the video image may be a 2D video or a 3D video, wherein the 3D video includes but is not limited to a rectangular 3D video, a semi-view 3D video, a panoramic 3D video or a fisheye 3D video.

Step S140: determining the target messages, and displaying the target messages in the target message display area; wherein the orthographic projection of the target message display area in the plane where the video image display area is located is located on the left side and/or right side of a preset central area of the video image display area.

In some embodiments, target messages include but are not limited to text messages (such as comments, bullet screens), image messages (such as emojis, pictures, virtual items, etc.).

In a specific implementation, the current user may invoke the message editing interface by a preset operation, edit and send the target messages, and display the target messages sent by the current user in the target message display area. In another specific implementation, the client may accept target messages from other clients sent by the server, and display the target messages from other clients in the target message display area.

For example, the target message display area may be located within the video image display area, or on the upper layer of the video image display area, or in front of the video image display area.

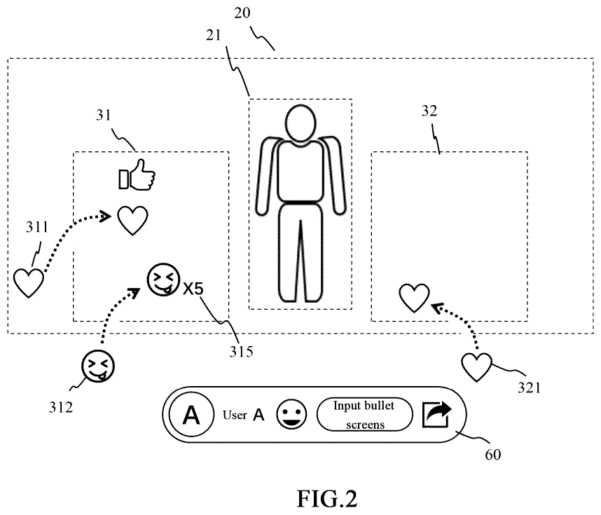

FIG. 2 is a schematic diagram of a video image display area and a target message display area provided according to an embodiment of the present disclosure. Referring to FIG. 2, the orthographic projection of the target message display areas 31 and 32 on the video image display area 20 is located outside the preset center area 21, causing the target message display areas 31 and 32 do not obstruct the preset center area 21.

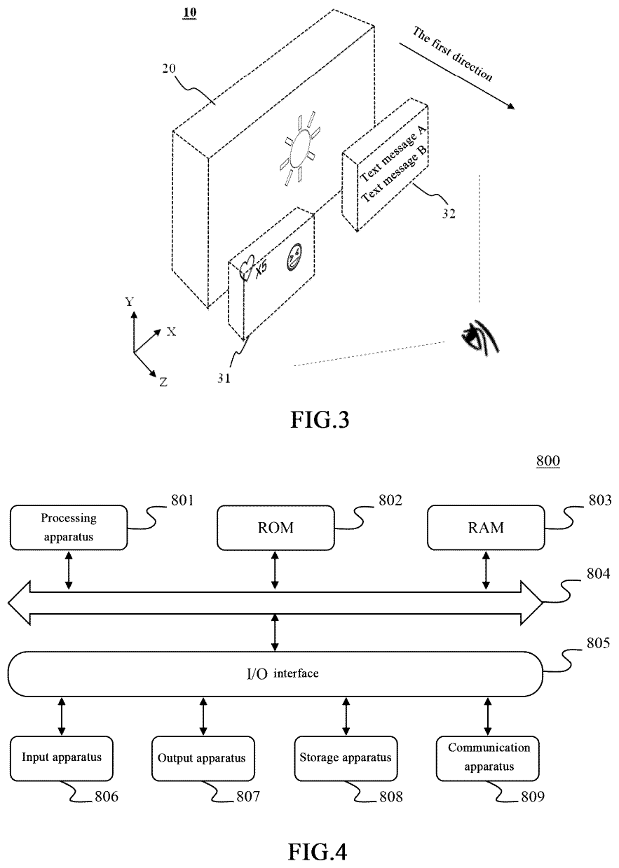

FIG. 3 is a schematic diagram of a video image display area and a target message display area in a virtual reality space provided according to an embodiment of the present disclosure. The virtual reality space 10 includes a video image display area 20, and target message display areas 31 and 32. In a first direction (i.e., the direction of the Z axis shown in FIG. 3), the target message display areas 31 and 32 are located in front of the video image display area, wherein the first direction is the direction in which the video image is facing, i.e., the direction opposite to the viewing direction when the user views the front video image. The orthographic projections of the target message display areas 31 and 32 on the video image display area 20 are located outside the preset central area.

It should be noted that the number of target message display areas may be one or more which is not limited in this embodiment.

According to the inventor's research, the expression or bullet screens interaction scheme provided by the relevant technology either spreads the expression or bullet screens over the entire video display interface for scrolling display, or displays it in other interfaces independent of the video display interface (e.g., a dedicated comment area), which makes it difficult for users to balance the video viewing experience and the bullet screens interaction experience. In this regard, according to one or more embodiments of the present disclosure, by locating the orthographic projection of the target message display area in the plane where the video image display area is located on a left side and/or a right side of the preset central area of the video image display area, the target message will not block the central area of the video image when displayed in the target message display area, and the target message area may be viewed by the user together with the video image, improving both the user's video viewing experience and message interaction experience.

It should be noted that those skilled in the art may set the position and size of the preset central area according to actual needs, which is not limited in the present disclosure.

In some embodiments, the orthographic projection of the target message display area in the plane where the video image display area is located is entirely or partially located in the video image display area. In this embodiment, the position of the target message display area is set so that the target message display area has an orthographic projection that is entirely or partially located in the video image display area, so that the target message display area does not leave the video image display area and surrounds the video image more closely, further improving both the user's video viewing experience and message interaction experience.

In some embodiments, the number of the target message display areas is more than two, and the orthographic projection of the target message display area in the video image display area is located on a left side and a right side of the preset central area of the video image display area.

In some embodiments, step S160 further includes:

Step B1: The target messages move toward the target message display area.

Referring to FIG. 2, the target message display areas 31 and 32 used to display image information (such as expressions or virtual items) are located on a left side and a right side of the preset central area 21, showing a visual effect that the target messages “closely surround” the performer. The determined target messages 311, 312 and 321 (for example, sent by the current user or sent by other users) may “fly” into the target message display area, presenting a visual effect of cheering or presenting gifts to the performer, thereby enriching the user's experience of interaction and enhancing the user participation.

In some embodiments, if the target messages originate from the current client (i.e. the local client), the target messages move along the first path; if the target messages originate from a client other than the current client (i.e. clients other than the local client), the target messages move along the second path.

In some embodiments, the second path may be a random path other than the first path. For example, multiple movement paths may be preset, so that one is randomly selected as the second path each time.

In this embodiment, target messages from different sources have different movement paths, which may facilitate the user to distinguish which target messages are sent by the user himself and which are sent by other users, thus improving the user's experience of interaction.

In some embodiments, the first path is a path between a message editing interface and the target message display area; the message editing interface is configured to edit and send target messages.

Exemplarily, after the user edits (e.g., inputs or selects) in the message editing interface and sends a target message, the target message may be directly moved from the message editing interface to the target message display area.

In some embodiments, target messages sent from the current client may be highlighted. For example, the target messages sent by the current client may be highlighted through different background colors, sizes of the target messages or other logos, animation effects, etc.

In some embodiments, if two or more identical first target messages are determined from the same client within a preset time period, the movement paths of the two or more identical first target messages are the same. For example, after the first target message A moves to the target message space along the path a, it may stay and be presented in the target message space for a preset time period (for example 2 seconds). During this period, if the same client sends the same first target message A again, the same first target message A will move along the same movement path an into the target message space, thereby presenting a visual effect of “continuous delivery”.

In some embodiments, a third identification corresponding to the two or more identical first target messages are displayed in the target message display area, and the third identification is used to display the number of first target messages currently arriving in the target message display area. For example, after the first target message A moves to the target message space, it may stay and be presented in the target message space A for a preset time period (for example 2 seconds). During this period, if the same client sends the same first target message A again, after the new first target message A arrives in the target message display area, an identification “×2” can be displayed, which is used to display in real time the number of first target message A that have continuously arrived in the target message space. Referring to FIG. 3, the third identification 315 shows “×5”, which indicates that the same client has currently sent 5 target messages 312 continuously. When the same client sends a new target message B, then the target message B can move through the new path.

Referring to FIG. 2, the current user A may input or select existing expressions or bullet screens into the message editing interface 60, or trigger other function menus, etc.

In some embodiments, when the message editing interface is evoked by a preset operation, the video image displayed in the video image display area may be switched from a 3D format to a 2D format to ensure that users may better focus on the message editing interface to edit the target messages when using the message editing interface (for example, editing target messages).

Furthermore, in some embodiments, after the message editing interface is hidden by a preset operation, the video image displayed in the video image display area may be switched from a 2D format to a 3D format.

In some embodiments, the target message is displayed with the user identification of the user who sent the target message. In this embodiment, by displaying the target message together with the user identification of its sender, it is convenient for the user to quickly identify the sender of the target message.

The information interaction method provided by one or more embodiments of the present disclosure may also adopt extended reality (XR) technology. Extended reality technology may combine reality and virtuality through a computer to provide users with a virtual reality space capable of human-computer interaction. The virtual reality space may be a simulation environment of the real world, a semi-simulated and semi-fictional virtual scene, or a purely fictional virtual scene. The virtual scene may be any of a two-dimensional virtual scene, a 2.5-dimensional virtual scene, or a three-dimensional virtual scene. The embodiment of the present application does not limit the dimension of the virtual scene. For example, the virtual scene may include the sky, land, ocean, etc., and the land may include environmental elements such as deserts and cities. Users may control virtual objects to move in the virtual scene.

Users may enter the virtual reality space through virtual reality devices such as helmet-mounted displays (HMDs), and control their own virtual characters (Avatars) in the virtual reality space to interact socially, entertain, learn, and work remotely with virtual characters controlled by other users.

A posture detection sensor (such as a nine-axis sensor) is provided in the virtual reality device to detect the posture change of the virtual reality device in real time. If the user wears the virtual reality device, when the user's head posture changes, the real-time posture of the head will be transmitted to the processor, so as to calculate the user's gaze point in the virtual environment, and calculate the image in the user's gaze range (i.e., virtual field of view) in the three-dimensional model of the virtual environment according to the gaze point, and display it on the display screen, so that people may have an immersive experience as if they were in a real environment.

In one embodiment, in the virtual reality space, the user may implement relevant interactive operations through a controller. The controller may be a handle. For example, the user performs relevant operation control by operating the buttons of the handle. Of course, in other embodiments, the target object in the virtual reality device may also be controlled by gestures, voice or multimodal control methods instead of using a controller.

In some embodiments, the virtual reality space includes a virtual live broadcast space. In the virtual live broadcast space, the performer user may live broadcast with a virtual image or a real image, and the audience user may control the virtual character to watch the performer's live broadcast from a viewing perspective such as a first-person perspective.

Accordingly, according to an embodiment of the present disclosure, a device for information interaction is provided, comprising:
a video display unit, configured to display a video image in a video image display area;
a message display unit, configured to determine a target message and display the target message in the target message display area; wherein the orthographic projection of the target message display area in the plane where the video image display area is located is located on a left side and/or a right side of a preset central area of the video image display area.

In some embodiments, the orthographic projection is entirely or partially located in the video image display area.

In some embodiments, the displaying of the target message in the target message display area comprises: moving the target message toward the target message display area.

In some embodiments, if the target messages originate from the current client, the target messages move along the first path; if the target messages originate from a client other than the current client, the target messages move along the second path.

In some embodiments, the first path is a path between a message editing interface and the target message display area; the message editing interface is configured to edit and send target messages.

In some embodiments, the second path is a random path other than the first path.

In some embodiments, the information interaction device further includes:
a path preset unit configured to preset two or more second paths;

The message display unit includes: a path selection unit configured to randomly select a second path from the two or more second paths as a moving path of the determined target message in response to determining a target message from a client other than the current client.

In some embodiments, if two or more identical first target messages from the same client are determined within a preset time period, the movement paths of the two or more identical first target messages are the same.

In some embodiments, the information interaction apparatus further includes:
an identification display unit, configured to display a third identification corresponding to the two or more identical first target messages in the target message display area, wherein the third identification is used to display the number of the first target messages currently arriving in the target message display area.

In some embodiments, the target message includes at least one of the following: an emoticon message, a picture message, a virtual item, and a text message.

In some embodiments, the target message is displayed with an identification of the user who sent the target message.

As for the apparatus embodiment, since it basically corresponds to the method embodiment, please refer to the partial description of the method embodiment for relevant details. The apparatus embodiments described above are only illustrative, and the modules described as separate modules may or may not be separate. Some or all of the modules can be selected according to actual needs to achieve the purpose of the solution of this embodiment. Persons of ordinary skill in the art can understand and implement the method without any creative effort.

Accordingly, according to one or more embodiments of the present disclosure, an electronic device is provided, including:
at least one memory and at least one processor;
wherein the memory is configured to store program codes, and the processor is configured to call the program codes stored in the memory to cause the electronic device to execute the method for information interaction provided according to one or more embodiments of the present disclosure.

Accordingly, according to one or more embodiments of the present disclosure, a non-transitory computer storage medium is provided, wherein the non-transitory computer storage medium stores program code, and the program code can be executed by a computer device to cause the computer device to execute the methods for information interaction provided according to one or more embodiments of the present disclosure.

Referring now to FIG. 4, a schematic structural diagram of an electronic device (e.g., terminal device or server) 800 suitable for implementing embodiments of the present disclosure is shown. Terminal devices in embodiments of the present disclosure may include, but are not limited to, mobile terminals such as mobile phones, notebook computers, digital broadcast receivers, PDAs (personal digital assistants), PADs (tablet computers), PMP (portable multimedia players), vehicle-mounted terminals (e.g. vehicle-mounted navigation terminals), etc. and fixed terminals such as digital TVs, desktop computers, etc. The electronic device shown in FIG. 4 is only an example and should not impose any limitations on the functions and scope of use of the embodiments of the present disclosure.

As shown in FIG. 4, the electronic device 800 may include a processing apparatus (e.g., central processing unit, graphics processor, etc.) 801 that may execute various appropriate actions and processes according to programs stored in a read-only memory (ROM) 802 or programs loaded into a random access memory (RAM) 803 from a storage apparatus 808. In the RAM 803, various programs and data required for the operation of the electronic device 800 are also stored. The processing apparatus 801, ROM 802 and RAM 803 are connected to each other via a bus 804. An input/output (I/O) interface 805 is also connected to bus 804.

Generally, the following apparatus may be connected to the I/O interface 805: an input apparatus 806 including, for example, a touch screen, touch pad, keyboard, mouse, camera, microphone, accelerometer, gyroscope, etc.; an output apparatus 807 including, for example, liquid crystal displays (LCDs), speakers, vibrators, etc.; a storage apparatus 808 including a magnetic tape, a hard disk, etc.; and a communication apparatus 809. The communication apparatus 809 may allow the electronic device 800 to communicate wirelessly or wiredly with other devices to exchange data. Although FIG. 4 illustrates an electronic device 800 having various apparatus, it should be understood that implementation or availability of all illustrated apparatus is not required. More or fewer apparatus may alternatively be implemented or provided.

In particular, according to embodiments of the present disclosure, the processes described above with reference to the flowcharts may be implemented as computer software programs. For example, embodiments of the present disclosure include a computer program product including a computer program carried on a computer-readable medium, wherein the computer program contains program code for performing the method illustrated in the flowchart. In such embodiments, the computer program may be downloaded and installed from the network via communication apparatus 809, or installed from storage apparatus 808, or installed from ROM 802. When the computer program is executed by the processing apparatus 801, the above-mentioned functions defined in the method of the embodiment of the present disclosure are performed.

It should be noted that the computer-readable medium mentioned above in the present disclosure may be a computer-readable signal medium or a computer-readable storage medium, or any combination of the above two. The computer-readable storage medium may be, for example, but is not limited to, an electrical, magnetic, optical, electromagnetic, infrared, or semiconductor system, apparatus or device, or any combination thereof. More specific examples of computer readable storage media may include, but are not limited to: an electrical connection having one or more wires, a portable computer disk, a hard drive, random access memory (RAM), read only memory (ROM), removable memory Programmable read-only memory (EPROM or flash memory), optical fiber, portable compact disk read-only memory (CD-ROM), optical storage means, magnetic storage means, or any suitable combination of the above. In this disclosure, a computer-readable storage medium may be any tangible medium that contains or stores a program for use by or in connection with an instruction execution system, apparatus, or means. In the present disclosure, a computer-readable signal medium may include a data signal propagated in baseband or as part of a carrier wave, carrying computer-readable program code therein. Such propagated data signals may take a variety of forms, including but not limited to electromagnetic signals, optical signals, or any suitable combination of the above. A computer-readable signal medium may also be any computer-readable medium other than a computer-readable storage medium that can send, propagate, or transmit a program for use by or in connection with an instruction execution system, apparatus, or means. Program code embodied on a computer-readable medium may be transmitted using any suitable medium, including but not limited to: wire, optical fiber cable, RF (radio frequency), etc., or any suitable combination of the foregoing.

In some embodiments, the client and server can communicate using any currently known or future developed network protocol such as HTTP (HyperText Transfer Protocol), and can connect with digital data communication (e.g., communications networks) in any form or medium. Examples of communications networks include local area networks (“LAN”), wide area networks (“WAN”), the Internet (e.g., the Internet), and end-to-end networks (e.g., ad hoc end-to-end networks), as well as any currently known or developed in the future network of.

The above-mentioned computer-readable medium may be included in the above-mentioned electronic device; it may also exist independently without being assembled into the electronic device.

The computer-readable medium carries one or more programs. When the one or more programs are executed by the electronic device, the electronic device performs the above-mentioned method of the present disclosure.

Computer program code for performing the operations of the present disclosure may be written in one or more programming languages, including object-oriented programming languages—such as Java, Smalltalk, C++, and conventional procedural programming language—such as “C” or a similar programming language. The program code may execute entirely on the user's computer, partly on the user's computer, as a stand-alone software package, partly on the user's computer and partly on a remote computer or entirely on the remote computer or server. In situations involving remote computers, the remote computer can be connected to the user's computer through any kind of network, including a local area network (LAN) or a wide area network (WAN), or can be connected to an external computer (such as through Internet connection by leveraging an Internet service provider).

The flowcharts and block diagrams in the figures illustrate the architecture, functionality, and operations of possible implementations of systems, methods, and computer program products according to various embodiments of the present disclosure. In this regard, each block in the flowchart or block diagram may represent a module, segment, or portion of code that contains one or more executable instructions for implementing specified logic functions. It should also be noted that, in some alternative implementations, the functions noted in the block may occur in an order that is different than the order noted in the figures. For example, two blocks shown one after another may actually execute substantially in parallel, or they may sometimes execute in the reverse order, depending on the function involved. It will also be noted that each block of the block diagram and/or flowchart illustration, and combinations of blocks in the block diagram and/or flowchart illustration, can be implemented by special purpose hardware-based systems that perform the specified functions or operations, or can be implemented using a combination of specialized hardware and computer instructions.

The units involved in the embodiments of the present disclosure may be implemented in software or hardware. Among them, names of the units do not constitute a limitation on the units themselves under certain circumstances.

The functions described above herein may be performed, at least in part, by one or more hardware logic components. For example, and without limitation, exemplary types of hardware logic components that may be used include: Field Programmable Gate Arrays (FPGAs), Application Specific Integrated Circuits (ASICs), Application Specific Standard Products (ASSPs), Systems on Chips (SOCs), Complex Programmable Logical device (CPLD) and so on.

In the context of this disclosure, a machine-readable medium may be a tangible medium that may contain or store a program for use by or in connection with an instruction execution system, apparatus, or device. The machine-readable medium may be a machine-readable signal medium or a machine-readable storage medium. Machine-readable media may include, but are not limited to, electronic, magnetic, optical, electromagnetic, infrared, or semiconductor systems, apparatus or devices, or any suitable combination of the foregoing. More specific examples of machine-readable storage media would include one or more wires based electrical connection, laptop disk, hard drive, random access memory (RAM), read only memory (ROM), erasable programmable read only memory (EPROM or flash memory), optical fiber, portable compact disk read-only memory (CD-ROM), optical storage device, magnetic storage device, or any suitable combination of the above.

According to one or more embodiments of the present disclosure, a method for information interaction is provided, comprising: displaying a video image in a video image display area; determining a target message, and displaying the target message in the target message display area; wherein the orthographic projection of the target message display area in the plane where the video image display area is located is located on a left side and/or a right side of a preset central area of the video image display area.

According to one or more embodiments of the present disclosure, the orthographic projection is entirely or partially located in the video image display area.

According to one or more embodiments of the present disclosure, displaying the target message in the target message display area comprises: moving the target message toward the target message display area.

According to one or more embodiments of the present disclosure, if the target messages originate from the current client, the target messages move along the first path; if the target messages originate from a client other than the current client, the target messages move along the second path.

According to one or more embodiments of the present disclosure, the first path is a path between a message editing interface and the target message display area; the message editing interface is used to edit and send target messages.

According to one or more embodiments of the present disclosure, the second path is a random path other than the first path.

According to one or more embodiments of the present disclosure, the information interaction method further includes: presetting two or more second paths; determining the target message and displaying the target message in the target message display area comprise: in response to determining a target message from a client other than the current client, randomly selecting a second path from the two or more second paths as the moving path of the determined target message.

According to one or more embodiments of the present disclosure, if two or more identical first target messages from the same client are determined within a preset time period, the movement paths of the two or more identical first target messages are the same.

The information interaction method provided according to one or more embodiments of the present disclosure further includes: displaying a third identification corresponding to the two or more identical first target messages in the target message display area, the third identification being configured to display the number of the first target messages currently arriving in the target message display area.

According to one or more embodiments of the present disclosure, the target message includes at least one of the following: an expression message, a picture message, a virtual item, and a text message.

According to one or more embodiments of the present disclosure, the target message is displayed with a user identification of the user that sent the target message.

According to one or more embodiments of the present disclosure, an apparatus for information interaction is provided, comprising: a video display unit, configured to display a video image in a video image display area; a message display unit, configured to determine a target message and display the target message in the target message display area; wherein the orthographic projection of the target message display area in the plane where the video image display area is located is located on a left side and/or a right side of a preset central area of the video image display area.

According to one or more embodiments of the present disclosure, an electronic device is provided, comprising: at least one memory and at least one processor; wherein the memory is used to store program code, and the processor is configured to call the program code stored in the memory so that the electronic device executes the information interaction method provided according to one or more embodiments of the present disclosure.

According to one or more embodiments of the present disclosure, a non-transitory computer storage medium is provided, the non-transitory computer storage medium stores program code, and when the program code is executed by a computer device, the computer device is caused to execute the method for information interaction provided according to one or more embodiments of the present disclosure.

The above description is only a description of the preferred embodiments of the present disclosure and the technical principles applied. Those skilled in the art should understand that the disclosure scope involved in the present disclosure is not limited to technical solutions composed of specific combinations of the above technical features, but at the same time, should also cover other technical solutions formed by any combination of the above technical features or their equivalent features without departing from the above disclosed concept, such as technical solutions formed by replacing the above features with (but not limited to) technical features having similar functions to the features disclosed in this disclosure.

Furthermore, although operations are depicted in a specific order, this should not be understood as requiring that these operations be performed in the specific order shown or performed in a sequential order. Under certain circumstances, multitasking and parallel processing may be advantageous. Likewise, although several specific implementation details are included in the above discussion, these should not be construed as limiting the scope of the present disclosure. Certain features that are described in the context of separate embodiments can also be implemented in combination in a single embodiment. Conversely, various features that are described in the context of a single embodiment can also be implemented in multiple embodiments separately or in any suitable sub-combinations.

Although the subject matter has been described in language specific to structural features and/or methodological acts, it is to be understood that the subject matter defined in the appended claims is not necessarily limited to the specific features or actions described above. Rather, the specific features and actions described above are merely example forms of implementing the claims.

1. A method for information interaction, comprising:
displaying a video image in a video image display area; and
determining a target message and displaying the target message in a target message display area; wherein orthographic projection of the target message display area in the plane where the video image display area is located is located on a left side and/or a right side of a preset central area of the video image display area.

2. The method of claim 1, wherein,
the orthographic projection is located entirely or partially in the video image display area.

3. The method of claim 1, wherein displaying the target message in the target message display area comprises:
moving the target message toward the target message display area.

4. The method of claim 3, wherein,
in response to the target message originating from a current client, the target message moves along a first path; and
in response to the target message originating from a client other than the current client, the target message moves along a second path.

5. The method of claim 4, wherein,
the first path is a path between a message editing interface and the target message display area; the message editing interface is used to edit and send the target message.

6. The method of claim 4, wherein,
the second path is a random path other than the first path.

7. The method of claim 6, further comprising:
presetting two or more second paths; and
wherein determining a target message and displaying the target message in the target message display area comprise: in response to determining a target message originating from a client other than the current client, randomly selecting a second path from the two or more second paths as a moving path of the determined target message.

8. The method of claim 3, wherein,
in response to two or more identical first target messages being determined from the same client within a preset time period, moving paths of the two or more identical first target messages are the same.

9. The method of claim 8, further comprising:
displaying a third identifier corresponding to the two or more identical first target messages in the target message display area, the third identifier being used to display a number of the first target messages currently arriving at the target message display area.

10. The method of claim 1, wherein the target message includes at least one of:
an emoticon message, a picture message, a virtual item, or a text message.

11. The method of claim 1, wherein the target message is displayed with a user identifier of a user sending the target message.

12. (canceled)

13. An electronic device, comprising:
at least one memory and at least one processor; and
wherein the memory is configured to store program codes, and the processor is configured to call the program codes stored in the memory to cause the electronic device to:
display a video image in a video image display area; and
determine a target message and displaying the target message in a target message display area; wherein orthographic projection of the target message display area in the plane where the video image display area is located is located on a left side and/or a right side of a preset central area of the video image display area.

14. A non-transitory computer storage medium, wherein,
the non-transitory computer storage medium has program codes stored thereon, which when executed by a computer device, causes the computer device to:
display a video image in a video image display area; and
determine a target message and displaying the target message in a target message display area; wherein orthographic projection of the target message display area in the plane where the video image display area is located is located on a left side and/or a right side of a preset central area of the video image display area.

15. The electronic device of claim 13, wherein,
the orthographic projection is located entirely or partially in the video image display area.

16. The electronic device of claim 13, wherein the electronic device is further caused to display the target message in the target message display area by:
moving the target message toward the target message display area.

17. The electronic device of claim 16, wherein,
in response to the target message originating from a current client, the target message moves along a first path; and
in response to the target message originating from a client other than the current client, the target message moves along a second path.

18. The electronic device of claim 17, wherein,
the first path is a path between a message editing interface and the target message display area; the message editing interface is used to edit and send the target message.

19. The electronic device of claim 17, wherein,
the second path is a random path other than the first path.

20. The electronic device of claim 19, the electronic device is further caused to:
preset two or more second paths; and
wherein determining a target message and displaying the target message in the target message display area comprise: in response to determining a target message originating from a client other than the current client, randomly selecting a second path from the two or more second paths as a moving path of the determined target message.

21. The electronic device of claim 16, wherein,
in response to two or more identical first target messages being determined from the same client within a preset time period, moving paths of the two or more identical first target messages are the same.
